(19) United States
(12) Patent Application Publication
(10) Pub. No.: US 2010/0232336 A1
(43) Pub. Date: Sep. 16, 2010

(54) SYSTEMS AND METHODS FOR SELECTING ANTENNAS FOR COORDINATED MULTIPOINT TRANSMISSION

(75) Inventors: Sayantan Choudhury, Vancouver, WA (US); Ahmad Khoshnevis, Portland, OR (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/404,259

(22) Filed: Mar. 13, 2009

(51) Int. Cl. H04H 20/71

(52) U.S. Cl. 370/312; 455/422.1

(57) ABSTRACT

A method of transmitting data from multiple base stations to a user equipment (UE) with possibly different numbers of antennas selected at the individual cooperating base stations is described. Also described is a method of transmitting data from a UE to multiple base stations with possibly different numbers of antennas selected at the individual cooperating base stations.

### TECHNICAL FIELD

The present disclosure relates generally to wireless communications. More specifically, the present disclosure relates to selecting antennas for coordinated multipoint transmission in a cellular network.

### BACKGROUND

A cellular network is a radio network made up of a number of radio cells (or just cells) each served by a fixed transmitter, known as a cell site or base station. These cells are used to cover different areas in order to provide radio coverage over a wider area than the area of one cell. Cellular networks include a set of fixed main transceivers each serving a cell and a set of distributed transceivers (which are generally, but not always, mobile) that provide services to the network's users.

There are a number of standards organizations that attempt to develop standards for cellular networks. One example of such a standards organization is the 3rd Generation Partnership Project (3GPP). 3GPP LTE (Long Term Evolution) is the name given to a project within 3GPP to improve the Universal Mobile Telecommunications System (UMTS) standard to cope with future technology evolutions. 3GPP LTE Advanced is currently being standardized by 3GPP as an enhancement of 3GPP LTE.

Coordinated multiple point transmission/reception (CoMP) is considered one of the promising technologies to improve the performance of 3GPP LTE Advanced. The main idea of CoMP is to transmit the information from multiple base stations to a user equipment (UE) resulting in better signal quality at the UE due to the combining capability of the multiple transmissions at the UE.

One form of combining proposed was MBSFN (Multicast Broadcast Single Frequency Network) like transmission where multiple base stations transmit the same signal to the UE. The main idea of the MBSFN is to transmit the same data from multiple base stations. At the receiving UE, the received signal appears to be from the sum of the individual channels from the individual base stations to the UE. The present disclosure relates to improvements to this MBSFN transmission scheme in the context of coordinated multiple point transmission/reception.

### BRIEF DESCRIPTION OF THE DRAWINGS

FIG. 1 illustrates downlink joint processing CoMP (coordinated multiple point transmission/reception) in LTE-Advanced;

FIG. 2 illustrates a method of selecting antennas for coordinated multi-point transmission;

FIG. 3 illustrates a system in which the method of FIG. 2 may be implemented;

FIG. 4 illustrates another system in which the method of FIG. 2 may be implemented, in which maximum singular values are utilized;

FIG. 5 illustrates another system in which the method of FIG. 2 may be implemented, in which a UE calculates combined channels corresponding to different antenna selections;

FIG. 6 illustrates a more detailed method of selecting antennas for coordinated multi-point transmission, which may be implemented in the system of FIG. 5;

FIG. 7 illustrates a system in which antenna selection methods described herein may be implemented with respect to CoMP on the uplink;

FIG. 8 illustrates a system that employs relays in which antenna selection methods described herein may be implemented with respect to CoMP on the uplink; and

FIG. 9 illustrates various components that may be utilized in a communication device.

### DETAILED DESCRIPTION

A method for coordinated multipoint transmission/reception is disclosed. A user equipment (UE) selects how many transmit antennas are to be used by multiple cooperating base stations. The UE notifies the multiple cooperating base stations about the selection. The UE receives downlink data simultaneously from the multiple cooperating base stations when different numbers of transmit antennas are selected at different cooperating base stations.

The UE may transmit uplink data simultaneously to the multiple cooperating base stations when different numbers of receive antennas are selected at the different cooperating base stations.

Selecting how many transmit antennas are to be used by the multiple cooperating base stations may include estimating channels from the individual cooperating base stations, and combining the channels to form an improved combined channel. Combining the channels to form the improved combined channel may include calculating performance metrics for different combinations of transmit antennas from the cooperating base stations.

Selecting how many transmit antennas are to be used by the multiple cooperating base stations may include estimating a superimposed channel of the cooperating base stations.

Notifying the multiple cooperating base stations about the antenna selection may include feeding back antenna selection indices to the cooperating base stations in order to allow the cooperating base stations to select the transmit antennas to be used.

Selecting how many transmit antennas are to be used by the multiple cooperating base stations may include using different metrics to estimate a configuration mode to be used at the cooperating base stations in order to improve a combined channel seen at the UE. The metrics may include at least one of capacity, diversity gain, and singular values.

In addition to selecting how many transmit antennas are to be used by multiple cooperating base stations, the UE may also select how many receive antennas are to be used by the UE.

A method for coordinated multipoint transmission/reception is also disclosed. A base station selects how many transmit antennas are to be used by the base station based on information received from a user equipment (UE). The base station transmits downlink data to the UE simultaneously with one or more other cooperating base stations when different numbers of transmit antennas are selected at the base station and the one or more other cooperating base stations.

The base station may receive uplink data from the UE simultaneously with the one or more other cooperating base stations when different numbers of receive antennas are selected at the base station and the one or more other cooperating base stations.

The base station may estimate a channel from the UE to the base station in order to form a better combined channel. The base station may combine individual channels from the UE to the base stations to form a better combined channel. The selection of the different numbers of receive antennas may improve an effective combined channel at the base station. Different metrics may be used to estimate a configuration mode to be used at the cooperating base stations in order to improve a combined channel seen at the base station.

The search space of combinations of antennas, and therefore reducing antenna selection feedback overhead, may be reduced by restricting the search to practically useful combinations.

A user equipment (UE) that is configured for coordinated multipoint transmission/reception is also disclosed. The UE includes a processor, memory in electronic communication with the processor, and instructions stored in the memory. The instructions are executable to select how many transmit antennas are to be used by multiple cooperating base stations. The instructions are also executable to notify the multiple cooperating base stations about the selection. The instructions are also executable to receive downlink data simultaneously from the multiple cooperating base stations when different numbers of transmit antennas are selected at different cooperating base stations.

A base station that is configured for coordinated multipoint transmission/reception is also disclosed. The base station includes a processor, memory in electronic communication with the processor, and instructions stored in the memory. The instructions are executable to select how many transmit antennas are to be used by the base station based on information received from a user equipment (UE). The instructions are also executable to transmit downlink data to the UE simultaneously with one or more other cooperating base stations when different numbers of transmit antennas are selected at the base station and the one or more other cooperating base stations.

In this disclosure, we improve upon the ideas of MBSFN transmission by smartly selecting the number of transmitting antennas at the individual cooperating base stations resulting in further improvement in performance. In effect, we make the new MBSFN combined channel better than the normal sum channel seen by the previous MBSFN scheme.

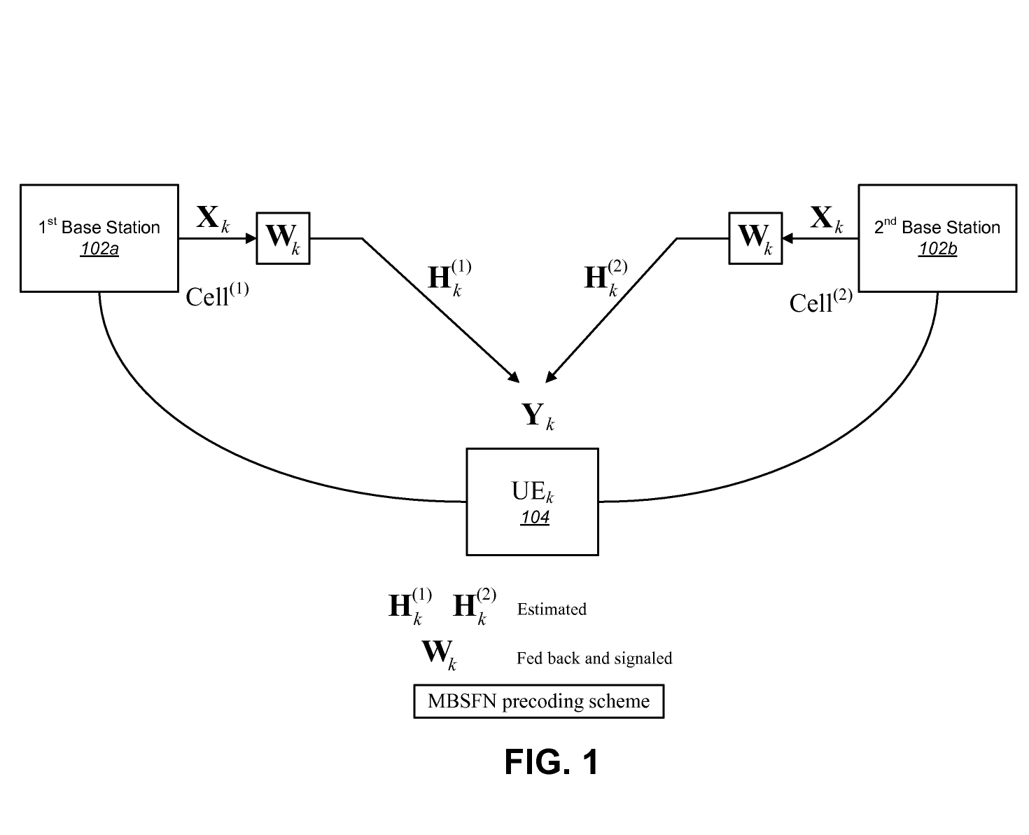

FIG. 1 shows multiple base stations 102, including a first base station 102a and a second base station 102b, transmitting data simultaneously to a UE 104. This is referred to as downlink joint processing CoMP (coordinated multiple point transmission/reception) in LTE-Advanced. The first base station 102a and the second base station 102b may be referred to as cooperating (or coordinating) base stations 102. In this context, cooperating (or coordinating) base stations 102 are base stations 102 that transmit the same data simultaneously to a UE 104.

Suppose the total number of CoMP cells (base stations 102) is B, each equipped with Nₜ transmit antennas. Let us assume that the receiver (the UE 104) has Nᵣ receive antennas. Let the baseband channel matrix between CoMP cell b (b=1, 2 . . . B) and UE; be denoted by Hᵢ(b) (Nᵣ×Nᵢ). Let Wₖ(b) be the pre-coding matrix of cell b with size Nₜ×Lₖ, where Lₖ is the number of transmission layers for UEₖ.

In MBSFN pre-coding:

$${y}_{k} = ( {\sum }_{b = 1}^{B} \sqrt{{P}_{b}} {H}_{k}^{( b )} {W}_{k} ) {x}_{k} + {n}_{k} \qquad ( 1 )$$

where Wₖ is a common pre-coding matrix for all CoMP cells, whose columns are the Lₖ right singular vectors corresponding to the Lₖ largest singular values of the composite channel

$${\sum }_{b = 1}^{B} {H}_{k}^{( b )} ,$$

and \sqrt{P_{b}} is the power on each layer from CoMP cell^{b}.

One of the problems with MBSFN pre-coding is that (with two cooperating base stations 102) even if the individual channels from the base stations 102 to the receiver (H1 and H2) are good, the combined channel (H1+H2) might not be good. Therefore, we propose the use of antenna selection at each of the cooperating points in order to select the best combined channel H1′+H2′, where H1′ and H2′ are chosen by selecting subsets of antennas at the individual cooperating base stations 102.

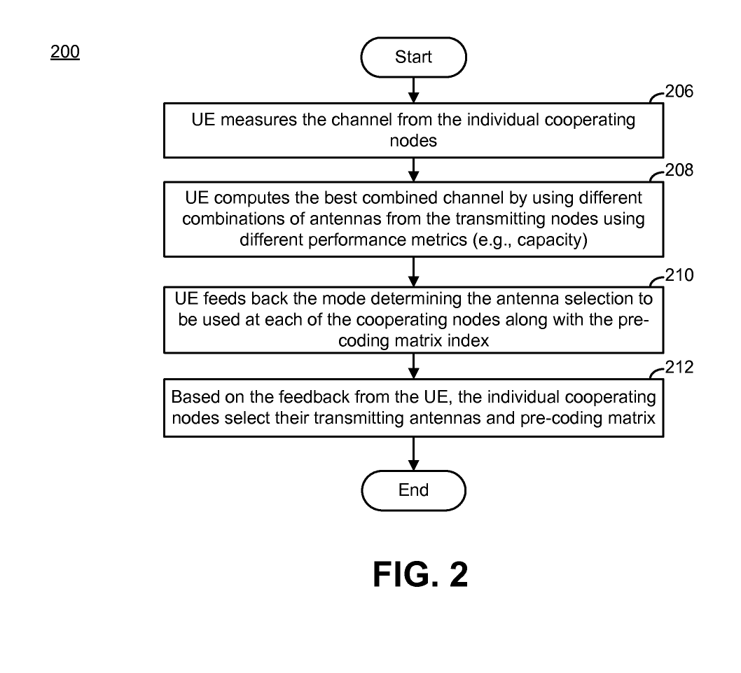

FIG. 2 illustrates a method 200 of selecting antennas for coordinated multi-point transmission. A UE 104 measures 206 (e.g., estimates) the channel from the individual cooperating nodes (e.g., base stations 102). The UE 104 computes 208 the best combined channel by using different combinations of antennas from the transmitting nodes using different performance metrics (e.g., capacity, BER, etc.). The UE 104 feeds back 210 the mode determining the antenna selection to be used at each of the cooperating nodes along with the pre-coding matrix index. Based on the feedback from the UE, the individual cooperating nodes select 212 their transmitting antennas and pre-coding matrix.

### Example 1

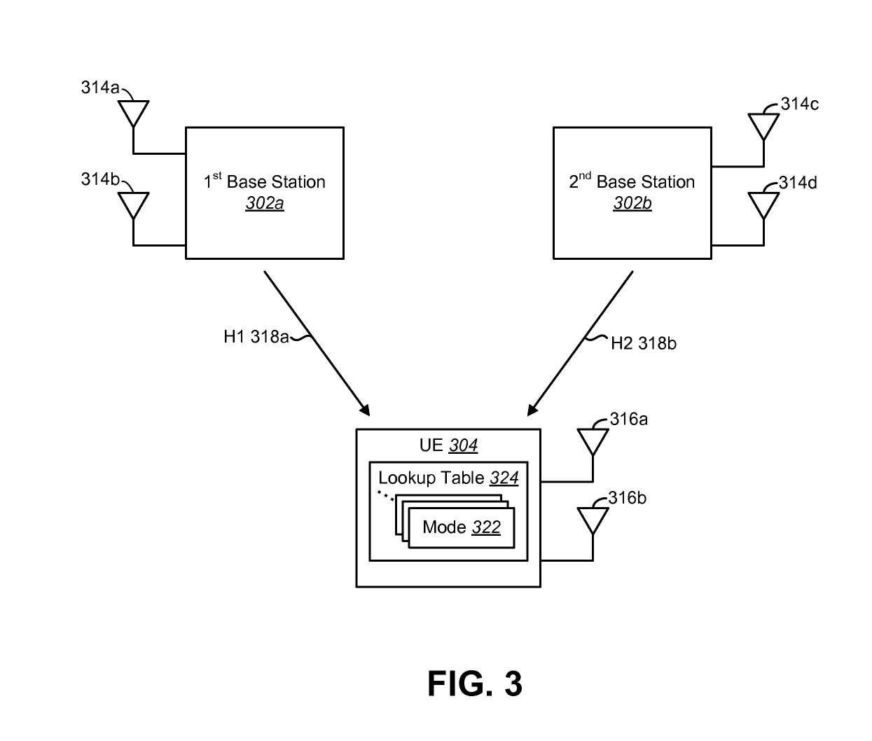

An example will now be discussed in relation to FIG. 3. Let us consider that there are two cooperating base stations 302: a first base station 302a and a second base station 302b. The first base station 302a has a first transmit antenna 314a and a second transmit antenna 314b. Similarly, the second base station 302b has a first transmit antenna 314c and a second transmit antenna 314d. The UE 304 has a first receive antenna 316a and a second receive antenna 316b.

Let us assume that the channel H1 318a from the first base station 302a to the UE 304 is given by:

H1=[a b; c d] (2)

where a is the channel gain from the first transmit antenna 314a to the first receive antenna 316a, b is the channel gain from the second transmit antenna 314b to the first receive antenna 316a, c is the channel gain from the first transmit antenna 314a to the second receive antenna 316b, and d is the channel gain from the second transmit antenna 314b to the second receive antenna 316b.

Let us also assume that the channel H2 318b from the second base station 302b to the UE 304 is given by:

H2=[e f; g h] (3)

where e is the channel gain from the first transmit antenna 314c to the first receive antenna 316a, f is the channel gain from the second transmit antenna 314d to the first receive antenna 316a, g is the channel gain from the first transmit antenna 314c to the second receive antenna 316b, and h is the channel gain from the second transmit antenna 314d to the second receive antenna 316b.

Hence, with a normal MBSFN transmission scheme, the combined (or superimposed) channel at the receiver is given by:

H=H1+H2=[a+e,b+f; c+g d+h] (4)

However, such a combined channel could be possibly worse than the individual channels H1 318a or H2 318b or other combinations of H1 318a and H2 318b. By using a different number of antennas 314 at the individual cooperating base stations 302, a different combined channel will be seen at the receiver and the receiver can choose the optimal combination of antennas 314 at the cooperating base stations 302. Some examples of possible combinations of antennas 314 are given below.

One possibility is to choose both antennas 314a, 314b from the first base station 302a and one antenna (the first antenna 314c or the second antenna 314d) from the second base station 302b and two antennas 316a, 316b at the UE 304. For example:

Mode 1

H′=[a+e b; c+g d] (5)

or

Mode 2

H′=[a b+f; c d+h] (6)

Another possibility is to choose one antenna (the first antenna 314a or the second antenna 314b) from the first base station 302a and both antennas 314c, 314d at the second base station 302b and two antennas 316a, 316b at the UE 304. For example:

Mode 3

H′=[a+e f; c+g h] (7)

or

Mode 4

H′=[e b+f; g d+h] (8)

Another possibility is to select both antennas 314a, 314b from the first base station 302a and none from the second base station 302b.

Mode 5

H′=H1 (9)

The UE 304 measures the individual channels H1 318a and H2 318b and then feeds back the antenna mode selection to be used for the individual base station 302. For instance, in the above example if the combined channel obtained by selecting two antennas 314a, 314b from the first base station 302a and the first antenna 314c from the second base station 302b leads to the best combined channel, the UE 304 feeds back “mode 1” to the cooperating base stations 302. The different modes 322 could be predefined by a lookup table 324.

### Example 2

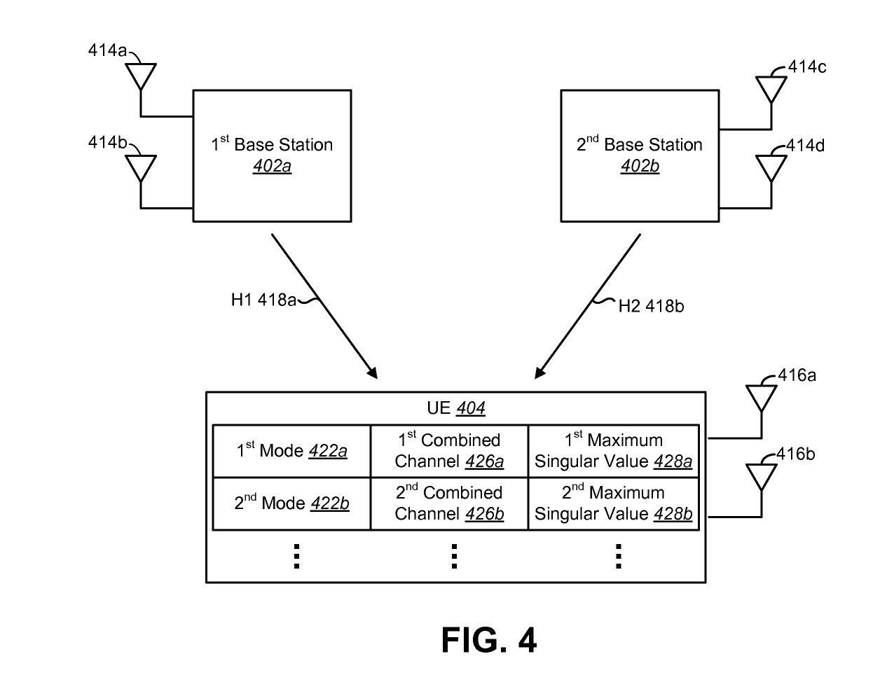

Referring now to FIG. 4, another example will be discussed. Once again, it will be assumed that there are two cooperating base stations 402: a first base station 402a and a second base station 402b. The first base station 402a has a first transmit antenna 414a and a second transmit antenna 414b. Similarly, the second base station 402b has a first transmit antenna 414c and a second transmit antenna 414d. The UE 404 has a first receive antenna 416a and a second receive antenna 416b. A first channel H1 418a from the first base station 402a to the UE 404 and a second channel H2 418b from the second base station 402b to the UE 404 are also shown.

In this example, we demonstrate the use of antenna selection to obtain the maximum singular value 428 of the combined channel 426. The maximum singular value 428 is a measure of the array gain in dominant eigenmode transmission, a method of extracting maximum diversity gain when the channel is known at the transmitter.

Let us consider two real matrices with individual entries selected from a Gaussian distribution with mean 0 and standard deviation 1.

Let:

$$A = [ \begin{matrix}0.6353 & 0.5512 \\ - 0.6014 & - 1.0998\end{matrix} ] \qquad ( 10 )$$

The maximum singular value of A is 1.4893.

Let:

$$B = [ \begin{matrix}0.0860 & - 0.4931 \\ - 2.0046 & 0.4620\end{matrix} ] \qquad ( 11 )$$

The maximum singular value of B is 2.0668.

The sum A+B is given by:

$$A + B = [ \begin{matrix}0.7213 & 0.0581 \\ - 2.6060 & - 0.6378\end{matrix} ] \qquad ( 12 )$$

with maximum singular value 2.7765, which is greater than the maximum singular value of A and B individually.

However, assuming that A represents the first channel H1 418a and that B represents the second channel H2 418b, the combined channel 426 by selecting two antennas 414a, 414b from the first base station 402a and the first antenna 414c from the second base station 402b is given by:

$$A + {B}^{′} = [ \begin{matrix}0.7213 & 0.5512 \\ - 2.6060 & - 1.0998\end{matrix} ] \qquad ( 13 )$$

whose maximum singular value is given by 2.9627, which is greater than the maximum singular value of the direct additive channel A+B. Hence, if the performance metric was the maximum singular value 428, this mode 422 using two antennas 414a, 414b from the first base station 402a and the first antenna 414c from the second base station 402b would be the preferred MBSFN transmission mode 422.

The UE 404 may calculate multiple maximum singular values 428 corresponding to different possible modes 422 (e.g., a first mode 422a where a first combined channel 426a has a first maximum singular value 428a, a second mode 422b where a second combined channel 426b has a second maximum singular value 428b, etc.). The mode 422 that provides the combined channel 426 having the highest maximum singular value 428 may then be selected and fed back to the base stations 402.

Different metrics could be used for the antenna mode selection, including but not limited to: the capacity of the combined channel 426, the determinant of the combined channel 426, the norm of the combined channel 426, the condition number of the combined channel 426, etc.

While the above description is for the downlink channel from the cooperating base stations 402 to the UE 404, a similar analysis holds for the uplink channel from the UE 404 to the base stations 402.

### Example 3

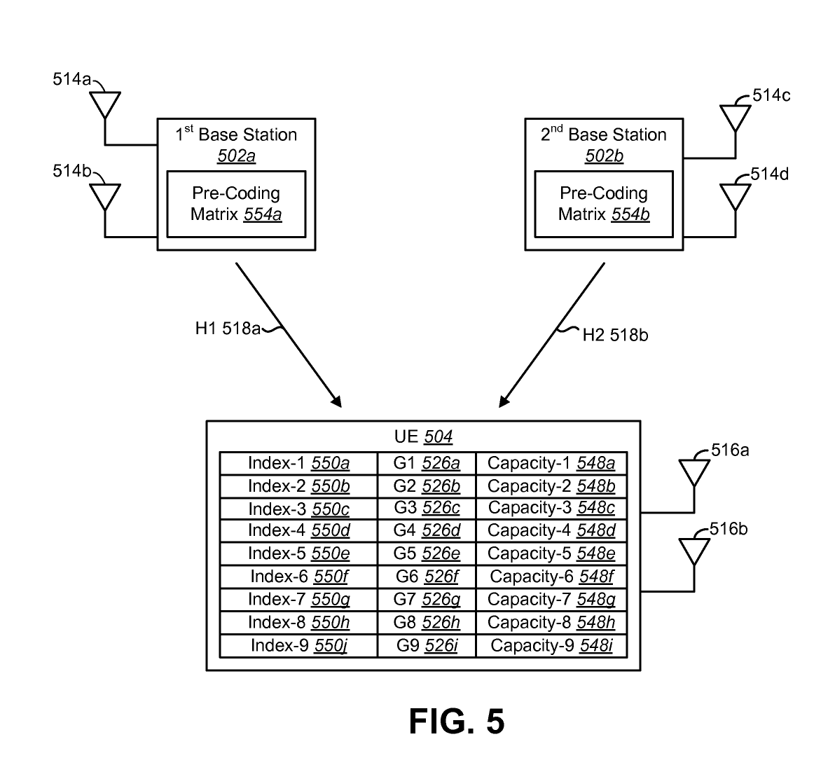

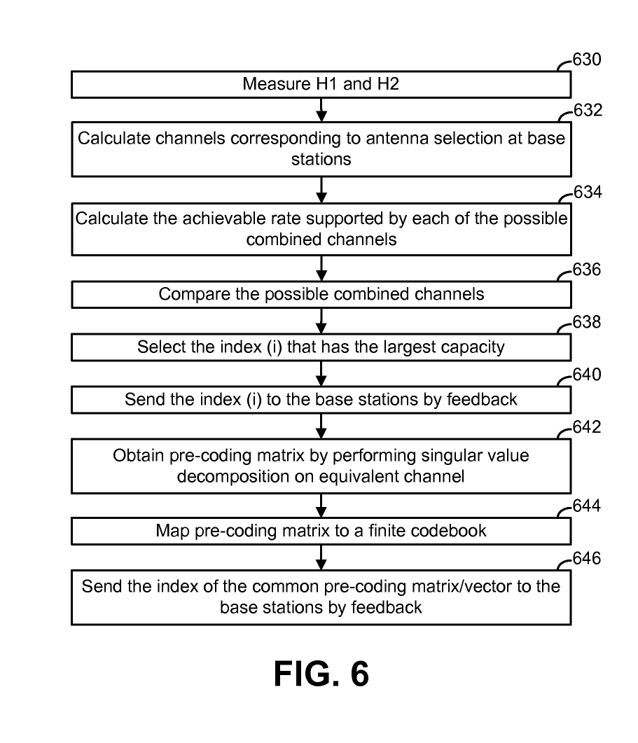

Another example will now be discussed, this time in relation to FIGS. 5 and 6. Assume a system as depicted in FIG. 5, in which the first base station 502a has two transmit antennas 514a, 514b, the second base station 502b has two transmit antennas 514c, 514d, and the UE 504 has two receive antennas 516a, 516b. Therefore, channels between the first base station 502a and the second base station 502b and the UE 504 are 2×2 matrices H1 518a and H2 518b.

FIG. 6 illustrates the procedure that is performed at the UE 504 for selecting transmit antennas 514. The UE 504 measures 630 (e.g., estimates) H1 518a and H2 518b. The UE 504 calculates 632 the combined channels 526a-i (represented by equations (14) through (22) below), each corresponding to an antenna selection at the base stations 502.

G1=αH1+βH2 (14)

In equation (14), it is assumed that the first base station 502a and the second base station 502b use all their antennas 514a, 514b, 514c, 514d sending the same signal.

G2=αH1+βH2(1) (15)

In equation (15), it is assumed that the first base station 502a uses both of its transmit antennas 514a, 514b, and that the second base station 502b uses its first transmit antenna 514c but not its second transmit antenna 514d. H2(1) is the first column of H2 518b.

G3=αH1+βH2(2) (16)

In equation (16), it is assumed that the first base station 502a uses both of its transmit antennas 514a, 514b, and that the second base station 502b uses its second transmit antenna 514d but not its first transmit antenna 514c.

G4=αH2+βH1(1) (17)

In equation (17), it is assumed that the second base station 502b uses both of its transmit antennas 514c, 514d, and that the first base station 502a uses its first transmit antenna 514a but not its second transmit antenna 514b.

G5=αH2+βH1(2) (18)

In equation (18), it is assumed that the second base station 502b uses both of its transmit antennas 514c, 514d, and that the first base station 502a uses its second transmit antenna 514b but not its first transmit antenna 514a.

G6=αH1(1)+βH2(1) (19)

In equation (19), it is assumed that the first base station 502a uses its first transmit antenna 514a but not its second transmit antenna 514b, and that the second base station 502b uses its first transmit antenna 514c but not its second transmit antenna 514d.

G7=αH1(1)+βH2(2) (20)

In equation (20), it is assumed that the first base station 502a uses its first transmit antenna 514a but not its second transmit antenna 514b, and that the second base station 502b uses its second transmit antenna 514d but not its first transmit antenna 514c.

G8=αH1(2)+βH2(1) (21)

In equation (21), it is assumed that the first base station 502a uses its second transmit antenna 514b but not its first transmit antenna 514a, and that the second base station 502b uses its first transmit antenna 514c but not its second transmit antenna 514d.

G9=αH1(2)+βH2(2) (22)

In equation (22), it is assumed that the first base station 502a uses its second transmit antenna 514b but not its first transmit antenna 514a, and that the second base station 502b uses its second transmit antenna 514d but not its first transmit antenna 514c.

The terms α and β in equations (14) through (22) represent the power distribution over the transmit antennas 514. For example, if the powers are equally distributed among the two transmit antennas 514, then α=½. Similarly, if only one transmit antenna 514 is being used, then α=1. In a more complex setting, one can allow any power distribution among the transmit antennas 514 as long as the total power constraint as well as individual antenna port power constraints are met.

The UE 504 calculates 634 the achievable rate (i.e., the capacity 548a-i) supported by each of the possible combined channels 526a-i. That is, the UE 504 computes:

Cᵢ=log₂(det(I+PₜₓGᵢGᵢ*)) (23)

where I is the identity matrix, Pₜₓ is the transmit power at the first base station 502a and the second base station 502b, and i=1, 2, . . . 9 is the index 550a-i of one of the nine combined channels 526a-i described above.

The UE 504 compares 636 the possible combined channels 526a-i and selects 638 the index (i) 550 that has the largest capacity C, 548. Reducing the number of combinations to eight combinations, the index (i) 550 can be sent 640 by feedback to the base stations 502 using three bits.

An exhaustive search involving Nₜ transmit antennas involves 2̂(Nₜ) possible combinations. However, we can reduce the search space by ensuring that we select at least one antenna from each of the cooperating base stations 502 and at least Nᵣ antennas in total from the cooperating base stations 502. Another possible combination is by selecting at least Nᵣ antennas from each of the cooperating base stations 502. In the example discussed above, there were 16 possible search combinations, but the search space was reduced to 9 meaningful combinations.

The pre-coding matrix 554 can be obtained 642 by performing singular value decomposition on the equivalent channel Gᵢ and can be mapped 644 to a finite codebook using existing techniques. The index of the common pre-coding matrix/vector 554 used by both base stations 502 is sent 646 back using feedback. The base stations 502a, 502b use the corresponding pre-coding matrix 554a, 554b along with the antenna selection determined by the UE 504.

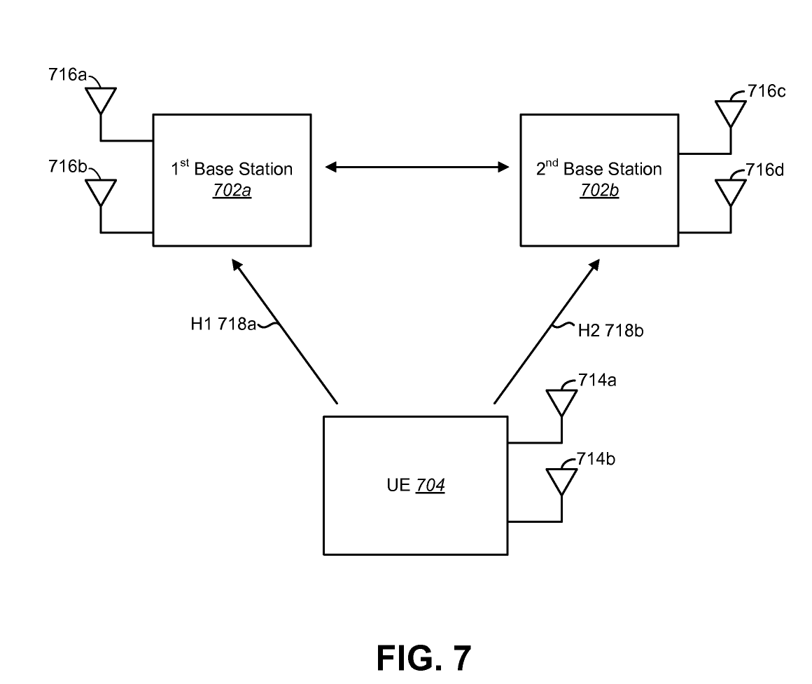

Another example will now be discussed in relation to FIG. 7. This example relates to CoMP on the uplink. Once again, it will be assumed that there are two coordinating base stations 702: a first base station 702a and a second base station 702b. The first base station 702a has a first receive antenna 716a and a second receive antenna 716b. The second base station 702b has a first receive antenna 716c and a second receive antenna 716d. The UE 704 has a first transmit antenna 714a and a second transmit antenna 714b.

In this method, the UE 704 transmits x (which represents uplink data) to the first base station 702a and the second base station 702b simultaneously. The channel from the UE 704 to the first base station 702a is H1 718a and from the UE 704 to the second base station 702b is H2 718b. The second base station 702b transmits the received signal y2=H2*x along with H2 (for simplicity, let us neglect the effect of noise) to the first base station 702a. The first base station 702a combines y2 to y1 (=H1*x) to obtain y=y1+y2=(H1+H2)*x, the same scenario as in the downlink. Based on the combined channel H1+H2, the first base station 702a feeds back the antennas 716 to be used for the second base station 702b and also determines the antennas 716 to be used for the first base station 702a.

Therefore, as with the downlink, different numbers of antennas 714, 716 may be in use at the base stations 702 and the UE 704. For example, one possibility is to choose both receive antennas 716a, 716b at the first base station 702a, one receive antenna (the first receive antenna 716c or the second receive antenna 716d) at the second base station 702b, and both transmit antennas 714a, 714b at the UE 704. Another possibility is to choose one receive antenna (the first receive antenna 716a or the second receive antenna 716b) at the first base station 702a, both receive antennas 716c, 716d at the second base station 702b, and both transmit antennas 714a, 714b at the UE 704. There are a number of other possibilities as well.

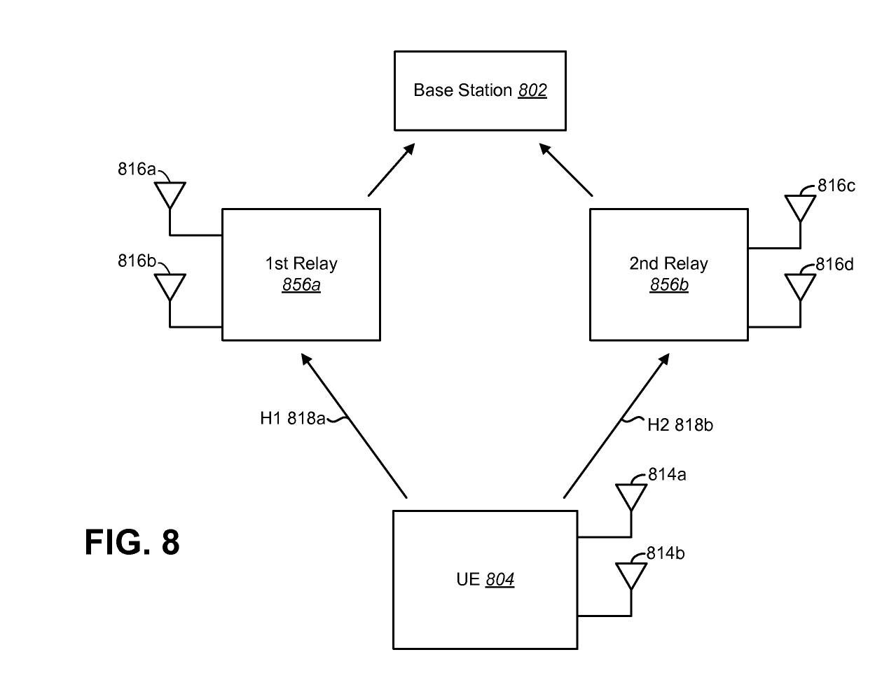

FIG. 8 illustrates a CoMP scheme on the uplink using relays 856. In this scheme, the UE 804 sends the uplink data to a first relay 856a and a second relay 856b, and the relays 856a, 856b relay the information to the base station 802. The received signal from the relays 856a, 856b at the base station 802 is given by y=H1*x+H2*x, where H1 818a is the channel from the first relay 856a to the base station 802 and H2 818b is the channel from the second relay 856b to the base station 802. Hence, the base station 802 can select the antennas 816a, 816b, 816c, 816d that are to be selected at the relay nodes 856 in order to optimize the combined channel at the base station 802.

The methods disclosed herein may be implemented in a 3GPP LTE-like system. The term “3GPP LTE-like system” includes any wireless communication system that operates in accordance with a 3GPP LTE standard, a 3GPP LTE-Advanced standard, etc.

The data that is transmitted from multiple cooperating base stations to a UE using the methods disclosed herein may be downlink shared data in a 3GPP LTE-like system. The term “downlink shared data” refers to data that is transmitted on a downlink channel that is shared by multiple UEs.

The data that is transmitted from a UE to multiple cooperating base stations using the methods disclosed herein may be uplink shared data in a 3GPP LTE-like system, including a 3GPP LTE-like system that employs relays. The term “uplink shared data” refers to data that is transmitted on an uplink channel that is shared by multiple UEs.

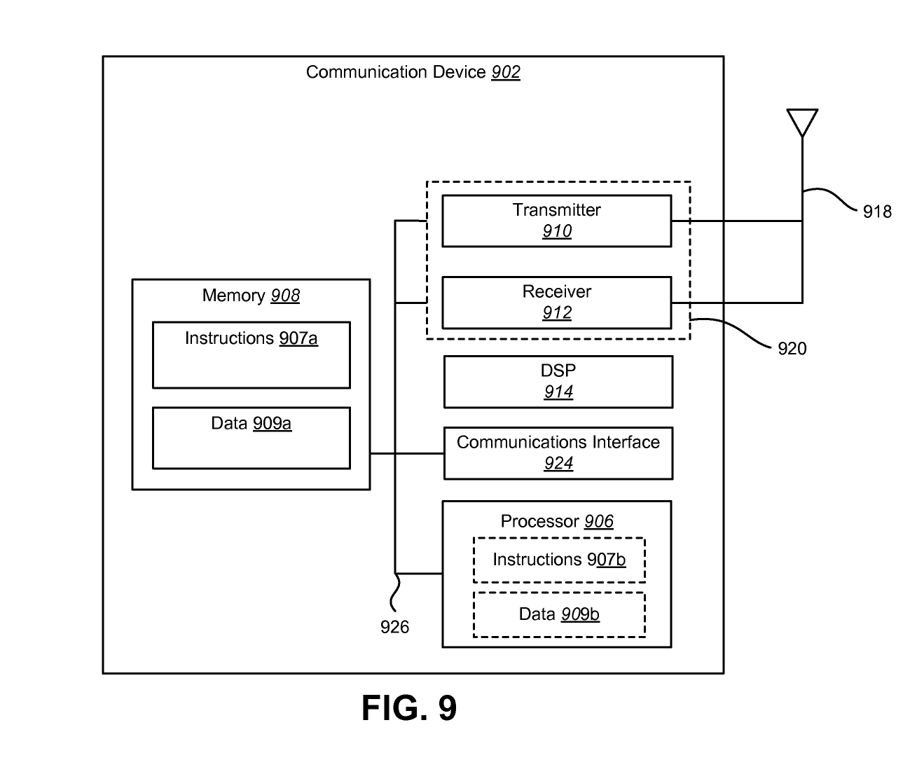

FIG. 9 illustrates various components that may be utilized in a communication device 902. The communication device 902 may be a UE or a base station. The communication device 902 includes a processor 906 that controls operation of the communication device 902. The processor 906 may also be referred to as a CPU. Memory 908, which may include both read-only memory (ROM), random access memory (RAM) or any type of device that may store information, provides instructions 907a and data 909a to the processor 906. A portion of the memory 908 may also include non-volatile random access memory (NVRAM). Instructions 907b and data 909b may also reside in the processor 906. Instructions 907b loaded into the processor 906 may also include instructions 907a from memory 908 that were loaded for execution by the processor 906.

The communication device 902 may also include a housing that contains a transmitter 910 and a receiver 912 to allow transmission and reception of data. The transmitter 910 and receiver 912 may be combined into a transceiver 920. An antenna 918 is attached to the housing and electrically coupled to the transceiver 920. Additional antennas may also be used.

The various components of the communication device 902 are coupled together by a bus system 926 which may include a power bus, a control signal bus, and a status signal bus in addition to a data bus. However, for the sake of clarity, the various buses are illustrated in FIG. 9 as the bus system 926. The communication device 902 may also include a digital signal processor (DSP) 914 for use in processing signals. The communication device 902 may also include a communications interface 924 that provides user access to the functions of the communication device 902. The communication device 902 illustrated in FIG. 9 is a functional block diagram rather than a listing of specific components.

As used herein, the term “user equipment” refers to an electronic device that may be used for voice and/or data communication over a wireless communication network, such as a cellular network. Examples of user equipment include cellular phones, personal digital assistants (PDAs), handheld devices, wireless modems, laptop computers, personal computers, etc. A user equipment may alternatively be referred to as an access terminal, a mobile terminal, a mobile station, a subscriber station, a remote station, a user terminal, a terminal, a subscriber unit, a mobile device, a wireless device, etc.

The term “base station” refers to a wireless communication station that is installed at a fixed location and used to communicate with UEs. A base station may alternatively be referred to as an access point, a Node B, an evolved Node B, etc.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for coordinated multipoint transmission/reception, the method being implemented by a user equipment (UE), the method comprising:
selecting how many transmit antennas are to be used by multiple cooperating base stations;
notifying the multiple cooperating base stations about the selection; and
receiving downlink data simultaneously from the multiple cooperating base stations when different numbers of transmit antennas are selected at different cooperating base stations.

2. The method of claim 1, further comprising transmitting uplink data simultaneously to the multiple cooperating base stations when different numbers of receive antennas are selected at the different cooperating base stations.

3. The method of claim 1, wherein selecting how many transmit antennas are to be used by the multiple cooperating base stations comprises:
estimating channels from the individual cooperating base stations; and
combining the channels to form an improved combined channel.

4. The method of claim 3, wherein combining the channels to form the improved combined channel comprises calculating performance metrics for different combinations of transmit antennas from the cooperating base stations.

5. The method of claim 1, wherein selecting how many transmit antennas are to be used by the multiple cooperating base stations comprises estimating a superimposed channel of the cooperating base stations.

6. The method of claim 1, wherein notifying the multiple cooperating base stations comprises feeding back antenna selection indices to the cooperating base stations in order to allow the cooperating base stations to select the transmit antennas to be used.

7. The method of claim 1, wherein the downlink data is downlink shared data in a 3GPP LTE-like system.

8. The method of claim 1, wherein selecting how many transmit antennas are to be used by the multiple cooperating base stations comprises using different metrics to estimate a configuration mode to be used at the cooperating base stations in order to improve a combined channel seen at the UE.

9. The method of claim 8, wherein the metrics comprise at least one of capacity, diversity gain, and singular values.

10. The method of claim 8, further comprising reducing the search space of combinations of antennas, and therefore reducing antenna selection feedback overhead, by restricting the search to practically useful combinations.

11. The method of claim 1, further comprising selecting how many receive antennas are to be used by the UE.

12. A method for coordinated multipoint transmission/reception, the method being implemented by a base station, the method comprising:
selecting how many transmit antennas are to be used by the base station based on information received from a user equipment (UE); and
transmitting downlink data to the UE simultaneously with one or more other cooperating base stations when different numbers of transmit antennas are selected at the base station and the one or more other cooperating base stations.

13. The method of claim 12, further comprising receiving uplink data from the UE simultaneously with the one or more other cooperating base stations when different numbers of receive antennas are selected at the base station and the one or more other cooperating base stations.

14. The method of claim 12, further comprising estimating a channel from the UE to the base station in order to form a better combined channel.

15. The method of claim 12, further comprising combining individual channels from the UE to the base stations to form a better combined channel.

16. The method of claim 13, wherein the selection of the different numbers of receive antennas improves an effective combined channel at the base station.

17. The method of claim 13, further comprising reducing the search space of combinations of antennas, and therefore reducing antenna selection feedback overhead, by restricting the search to practically useful combinations.

18. The method of claim 13, wherein the uplink data is uplink shared data in a 3GPP LTE-like system that employs relays.

19. The method of claim 13, further comprising using different metrics to estimate a configuration mode to be used at the cooperating base stations in order to improve a combined channel seen at the base station.

20. A user equipment that is configured for coordinated multipoint transmission/reception, comprising:
a processor;
memory in electronic communication with the processor; and
instructions stored in the memory, the instructions being executable to:
select how many transmit antennas are to be used by multiple cooperating base stations;
notify the multiple cooperating base stations about the selection; and
receive downlink data simultaneously from the multiple cooperating base stations when different numbers of transmit antennas are selected at different cooperating base stations.

21. The user equipment of claim 20, wherein the instructions are also executable to transmit uplink data simultaneously to the multiple cooperating base stations when different numbers of receive antennas are selected at the different cooperating base stations.

22. The user equipment of claim 20, wherein the instructions executable to select how many transmit antennas are to be used by the multiple cooperating base stations comprise instructions executable to:
estimate channels from the individual cooperating base stations; and
combine the channels to form an improved combined channel.

23. The user equipment of claim 20, wherein the instructions executable to notify the multiple cooperating base stations comprise instructions executable to feed back antenna selection indices to the cooperating base stations in order to allow the cooperating base stations to select the transmit antennas to be used.

24. The user equipment of claim 20, wherein the instructions executable to select how many transmit antennas are to be used by the multiple cooperating base stations comprise instructions executable to use different metrics to estimate a configuration mode to be used at the cooperating base stations in order to improve a combined channel seen at the UE.

25. A base station that is configured for coordinated multipoint transmission/reception, comprising:
a processor;
memory in electronic communication with the processor; and
instructions stored in the memory, the instructions being executable to:
select how many transmit antennas are to be used by the base station based on information received from a user equipment (UE); and
transmit downlink data to the UE simultaneously with one or more other cooperating base stations when different numbers of transmit antennas are selected at the base station and the one or more other cooperating base stations.

26. The base station of claim 25, further comprising instructions executable to receive uplink data from the UE simultaneously with the one or more other cooperating base stations when different numbers of receive antennas are selected at the base station and the one or more other cooperating base stations.

27. The base station of claim 25, further comprising instructions executable to estimate a channel from the UE to the base station in order to form a better combined channel.

28. The base station of claim 25, further comprising instructions executable to use different metrics to estimate a configuration mode to be used at the cooperating base stations in order to improve a combined channel seen at the base station.
